(19) United States
(12) Patent Application Publication
(10) Pub. No.: US 2012/0051647 A1
(43) Pub. Date: Mar. 1, 2012

(54) ICON DESIGN AND METHOD OF ICON RECOGNITION FOR HUMAN COMPUTER INTERFACE

(75) Inventor: Zhi Gang Tan, Hong Kong (CN)

(73) Assignee: Hong Kong Applied Science and Technology Research Institute Company Limited, Shatin (HK)

(21) Appl. No.: 12/873,547

(22) Filed: Sep. 1, 2010

(51) Int. Cl. G06K 9/46

(52) U.S. Cl. 382/192

(57) ABSTRACT

An icon for a machine recognition system has a frame element and a symbol associated with the frame element. The icon can be defined by a model-collection of frame keypoints. The icon can be recognized by identifying an image-collection of frame keypoints within the image that matches the model-collection of frame keypoints and by recognizing a symbol associated with the image-collection of keypoints that is identified.

### FIELD OF THE INVENTION

The current invention relates to computer vision and more particular to methods of recognizing objects, for example icons and symbols, in an image. It also relates to the design of an icon for a computer vision system

### BACKGROUND TO THE INVENTION

Computer vision is the scientific discipline of making machines that can “see” so that they can extract information from an image and based on the extracted information perform some task or solve some problem. The image data can take many forms, such as still images, video, views from multiple cameras, or multi-dimensional data from a medical scanner.

Machines such as computers work well at seeing complex patterns or rich features in images however, they have much less success when the pattern being looked for is simple and easily confused with background or irrelevant or commonplace objects. This limits the freedom of expression of designers who are constrained by what machines can reliable see and which might not be visually appealing to human users.

The problem worsens when there is also some recognition or interaction with human users. Human users on the other hand find it easier to recognize simple yet meaningful graphic symbols such as for example the common triangle, square and circle used to represent play, stop and record in multimedia controls. Hitherto machines simply could to reliably recognize such simple symbols in an image containing a plethora of other foreground and background objects. Many designers also use a unified theme in aspects such as shape and texture for symbols to make systems more aesthetically pleasing. Although such symbols are more complex and easily recognized there are problems associated with distinguishing between similar or identical objects or symbols in the same image.

A number of fast and robust recognitions methods are available for as SIFT, SURF and RANSAC/PROSAC, which are discussed later in this document. Such methods however suffer for a problem of not being able to reliably locate two similar or identical objects or symbols in the same image. One known method that can locate multiple similar or identical objects in an image is the Hough Transform. The Hough Transform can be used to robustly detect multiple similar icons in the input image. However this method is a parameter space analysis technique and, in our case needs to explore a large parameter space (The homography has 9 dimensions) and so is relatively slow so might not be suitable for real time recognition systems.

### SUMMARY OF THE INVENTION

Accordingly, there is disclosed herein a method in a computer of recognizing an icon in an image, the icon comprising a collection of frame keypoints and a symbol associated with the collection of frame keypoints, the method comprising providing a model comprising a model-collection of frame keypoints, identifying an image-collection of frame keypoints within the image that matches the model-collection of frame keypoints, recognizing a symbol within the image, the symbol being associated with the identified image-collection of frame keypoints, and initiating an action within the computer or another connected computer, wherein the action is associated with the symbol.

Identifying an image-collection of the frame keypoints may comprise detecting image keypoints within the image and identifying an image-collection of frame keypoints from within the image keypoints, the image-collection of frame keypoints matching the model-collection of frame keypoints.

Identifying the matching image-collection of frame keypoints within the image may comprise identifying within the image a first constrained search window having a first plurality of regions, identifying within the image a second constrained search window having a second plurality of regions, at least one of the first regions intersection with at least one of the second regions, and iteratively searching the first search window for a matching image-collection of the frame keypoints and then searching the second search window for a matching image-collection of the frame keypoints. The iterative searching may comprise identifying a first matching image-collection of the frame keypoints in the first search window and eliminating image keypoints in the first matching collection from the searching of the second search window.

In one aspect identifying a matching image-collection of frame keypoints within the image may comprise detecting image keypoints within the image, identifying in the first search window a first matching image-collection of the keypoints that matches the model-collection of frame keypoints, eliminating the first matching image-collection of keypoints from the detected image keypoints and searching the second search window for a second matching image-collection of the keypoints that matches the model-collection of frame keypoints.

The method may further comprise a step of eliminating outliers from the detected image keypoints.

The frame image-collection of frame keypoints within the image may comprise a collection of images pixels exhibiting amplitude extrema from surrounding pixels.

The model-collection of frame keypoints may define points on a frame surrounding the symbol, or may define points on a complex image feature adjacent to the symbol.

The model-collection of frame keypoints is unique from any keypoint of the symbol.

The symbol may also define by a collection of symbol keypoints and wherein the collection of frame keypoints is larger than the collection of symbol keypoints.

There is also disclosed herein a method in a computer of recognizing an icon in an image, the icon comprising a collection of frame keypoints and a symbol associated with the collection of frame keypoints, the method comprising providing a model comprising a model-collection of frame keypoints, detecting set of image keypoints within the image, identifying a plurality of overlapping search windows within the image, each search window having a first region in common with an adjacent search window and a second unique region not shared by any other search window, iteratively searching each search window, the searching comprising searching the image keypoints within one of the search windows for a first image-collection of image keypoints matching the model-collection of frame keypoints, eliminating any members of the image-collection from the detected set of image keypoints, and searching the remaining image keypoints within an adjacent one of the search windows for a second image-collection of the image keypoints that matches the model-collection of frame keypoints, recognizing a symbol within the image, the symbol being associated with one of the identified image-collections of frame keypoints, and initiating an action within the computer or another connected computer, wherein the action is associated with the symbol.

There is also disclosed herein an apparatus for recognizing an icon in an image, the icon comprising frame defined by a collection of frame keypoints and a symbol associated with the frame, the apparatus comprising means for displaying or receiving an image to/from user, storage member, a model stored on the memory, the model comprising a model-collection of frame keypoints, means for identifying an image-collection of frame keypoints within the image that matches the model-collection of frame keypoints, means for recognizing a symbol within the image, the symbol being associated with the identified image-collection of frame keypoints, and means initiating an action within the computer or another connected computer, wherein the action is associated with the symbol.

There is also disclosed here the design of an icon for a computer vision system, comprising a simple meaningful symbol element combined with a complex frame element.

Further aspects of the invention will become apparent from the following description, which is given by way of example only to illustrate the invention.

### BRIEF DESCRIPTION OF THE DRAWINGS

Examples of the invention will now be described with reference to the accompanying drawings in which:—

FIG. 1 is a schematic illustration of a computer network in which a preferred embodiment of the invention is implemented,

FIG. 2 is a schematic illustration of a computer in which a preferred embodiment of the invention is implemented.

FIGS. 3a and 3b are illustrative examples of icons according the invention,

FIG. 4 is a flow diagram of a single interaction of a recognition method according to the invention,

FIG. 5 is a flow diagram of the AdaBoost method of the invention,

FIG. 6 illustrates the output of the AdaBoost algorithm used to speed up frame recognition,

FIG. 7 is a flow diagram of a method verifying the presence of an icon using a homography,

FIG. 8 illustrates a plurality of search windows and search regions according to the invention, and

FIG. 9 is a flow diagram of one example of the invention.

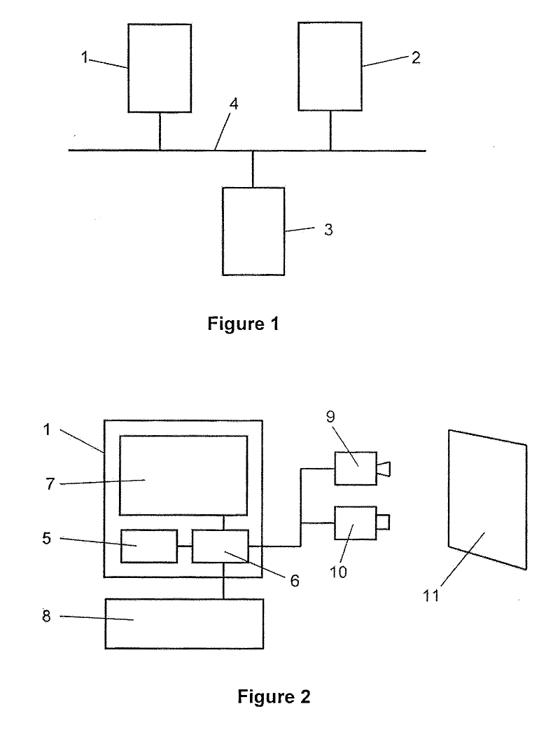

### DETAILED DESCRIPTION OF THE PREFERRED EMBODIMENTS

Before the exemplary embodiments of the invention are described in detail, it is to be understood by those skilled in the art that the invention is not limited to the details of arrangements set forth in the following description or illustrated in the accompanying drawings. The invention is capable of other embodiments and of being practiced or of being carried out in various ways. Also, it is to be understood that the phraseology and terminology used herein is to illustrate the invention and should not be regarded as limiting the scope of use of functionality thereof.

Embodiments of the invention will be described as practiced in a vision recognition computer system. Such a computer system has a computer 1 connected with a one or more servers 2 and one of more other computers 3 by a network 4, which may include a wireless or wired LAN, and adhoc network or the Internet, for the exchange of data and issuing of commands or actions between computers. The computer 1 comprises, but is not limited to, a memory 5 for both temporary and permanent storage of data and a processor 6 connect with the memory 5 for reading computer readable instructions also stored on the memory and performing various tasks and method in accordance with said instructions. Various peripherals are connected with the computer 1 for providing interaction with the outside word, including but not limited to, a display device 7 for outputting a information, images and video to a user and user input device 8 such as a games controller, keyboard or other device for providing user input to the computer. An image capture device 9 may also be provided for allowing input of still or video images to the computer and is particularly useful, although not essential, for the current invention. An image projector 10 can also be provided in addition to or as an alternative to the display 7 for projecting and image from the device onto a projection screen 11 or other suitable substrate. A computer 1 and computer system of this type can be used for various functions such as for education, entertainment such as playing games and augmented reality, image and video editing, and data analysis and manipulation. A method of recognizing an icon in an image in accordance with the current invention can be used with such a computer system for many practical and useful purposes in which images containing icons can be projected onto surfaces which users can interact with the icons. The method may also find application in systems where a computer system can search for and respond to symbols etc in received of input still and video images or other image media. The skilled addressee will also understand that the invention is not limited to application in “PC” based computer systems but may also be used in electronic devices which contain a processor and memory such as electronic books, handheld display devices or personal media players which a user can interaction with icons displayed on a touch screen for example. The method of the invention may also be implemented in hardware such as well as software.

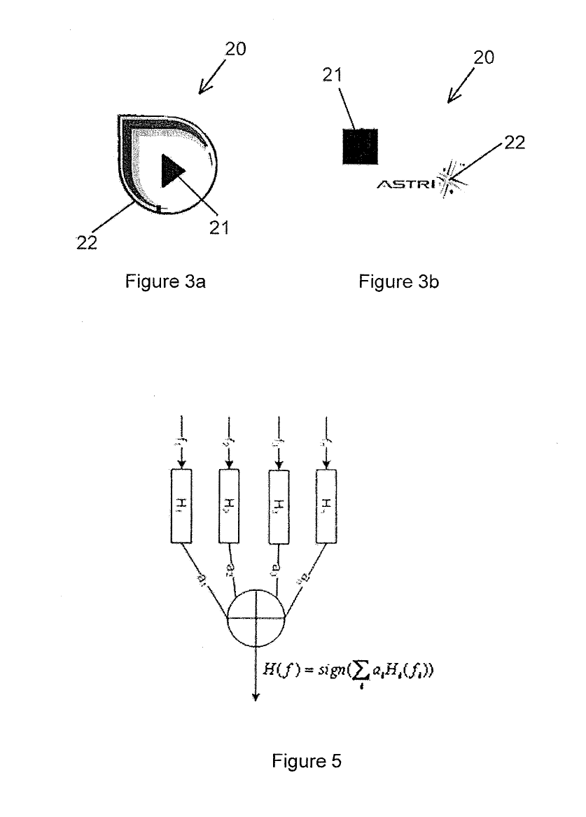

In order to overcome recognition difficulties associated with simple yet meaningful graphic symbols such as the common multimedia symbols of “triangle” for play, “square” for stop, “parallel lines” for pause, “circle” for record and +/− for up/down such symbols are incorporated into an icon which includes a more complex frame element as illustrated in FIGS. 3a and 3b. The icon 20 combines a simple graphical symbol 21 such as a particular object mark that represents something else to a user by association or convention, together with a more complex frame element 22, which may be meaningless to the user but which defines a unique collection of keypoints that are more easily recognized by an image recognition algorithm. The frame element 22 may be a surrounding frame element, which defines keypoints completely or partially surrounding the symbols element 21 of the icon, as illustrated in FIG. 3a, or may be a more complex symbol, mark, logo or other insignia adjacent relationship with the symbol part of the icon as illustrated in FIG. 3b. The frame element 22 must contain sufficient characterizing features to provide a unique collection of keypoints to enable easy recognition by the computer system, thus the frame element 22 should not itself be a simple geometric shape such as circle, square, rectangle or triangle. A collection of robust frame keypoints from the frame element 22 can be found using SIFT, SURF or other interest point detection methods which are described later. The collection of frame keypoints defining the frame element 22 is stored in a frame model for later access by an icon recognition method.

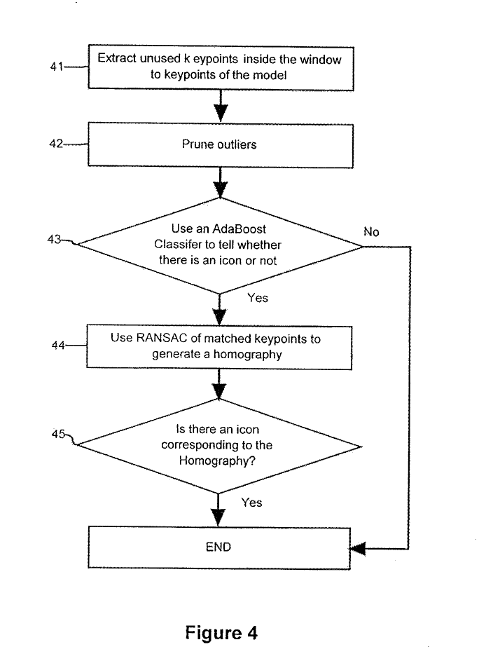

A method in a computer of recognizing an icon in an image is shown in FIG. 4. Block 41 directs the computers to firstly obtain a set of image keypoints from an image under observation. The image keypoints can in the most simple form local amplitude extrema for pixels such as local maximum or local minimum amplitude values relative to selected neighboring pixels. Various detection methods can be used to analysis the image and obtain a set of image keypoints. The inventors have successfully used SURF as well as other detection methods such as SIFT, FAST (for details see: Edward Rosten, Tom Drummond: Machine learning for high-speed corner detection: May 2006 Publication: European Conference on Computer Vision), FERNS (for details see: Ozuysal M., Calonder M., Lepetit V., Fua P.: Fast Keypoint Online Learning and Recognition. IEEE Transactions on Pattern Analysis and Machine Intelligence (PAMI), Vol. 32, Nr. 3, pp. 448-461, March 2010) and HIP (for details see: Simon Taylor, Edward Rosten, Tom Drummond: Robust Feature Matching in 2.3 μs, June 2009, IEEE CVPR Workshop on Feature Detectors and Descriptors: The State Of The Art and Beyond).

Once the set of keypoints in the image is obtain a recognition algorithm such as a Random Sample Consensus (RANSAC) method or its fast variant Progressive Sample Consensus (PROSAC), which provides robust fitting of the model in the presence of many data outliers, can be used to locate and identify a frame (for example a collection of frame keywords) in the image. In order to speed up the RANSAC/PROSAC method Block 42 directs the computer to prune obvious outliers in the image keypoint set before the RANSAC/PROSAC. Keypoint outliers occur where there is more that one icon in the image or from noise or other features in the image. The outliers are pruned by matching descriptors of image keypoints with model keypoint descriptors. Similar descriptors are ordered in groups and only the most similar descriptors in each group is retained. All other descriptors are considered “outliers” and thus discarded or pruned. This method can result in keypoints of actual matching icons being discarded, but the complex frame has many keypoints and the loss of a few keypoints in this manner does not affect the robustness of the recognition method. Pruning the outliers is preferably, although optional.

Secondly one can also use a boost algorithm such as AdaBoost prior to RANSAC/PROSAC to improve recognition performance as directed in Block 43 of FIG. 4. AdaBoost is used to identify if the set of image keypoints does not contain a collection of keypoints matching the model collection of frame keypoints. If the set of image keypoints does not contain a collection of keypoints then there is no frame matching the model in the image and the method can end, otherwise if the presence of keypoints matching the model is not discounted, that is to say there is a high probability of an icon being present in the search image or window, RANSAC/PROSAC is used to located and identify any frame matching the model in the image. There are a number of boosting methods similar to AdaBoost and it should be understood by the skilled addressee that such other known boosting methods may also be used. The AdaBoost algorithm is used to combine a group of weak keypoint classifiers to obtain a strong keypoint classifier. Referring to FIG. 5, the output of the AdaBoost algorithm is a weighted combination of all output of weak classifiers in the following form:

$$H ( f ) = sign ( {\sum }_{i} {a}_{i} {H}_{i} ( {f}_{i} ) )$$

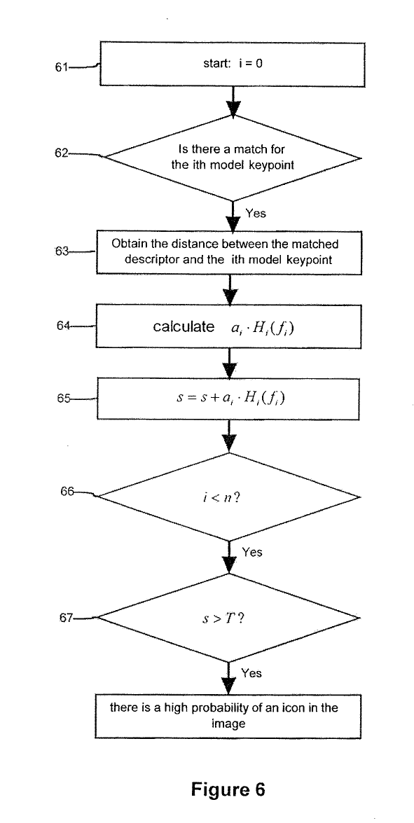

The weak classifier Hᵢ is simply a stump function-a classification tree with one split. Here, the feature fᵢ is the Euclidean distance between the descriptor vector of a model keypoint and the descriptor vector of the closest corresponding keypoint in the searched image. The values of aᵢ can be obtained through training as is known in the art. In the present invention it is preferable to train the AdaBoost classifier to have high detection rate at the cost of low missing rate. A particular example of the AdaBoost method is shown in FIG. 6. The method loops between Blocks 61 and 66 n times, where i is an index for the image keypoint under consideration. At Block 62 the method finds the closets match in the image keypoints for the ith model keypoint. Block 63 then obtains the Euclidean distance between the descriptor vector of the closest match image keypoint and the descriptor vector of the ith model keypoint. Blocks 64 and 65 multiply the Euclidean distance by the constant aᵢ and sum the value for each keypoint in the image. After the loop finishes Block 67 compares the summed total with a learned constant T. If the summed total s is greater than T then there is a high probability that there is an icon in the image. If s is less than T then there is a high probability that there is no icon in the image and the method of FIG. 4 can end.

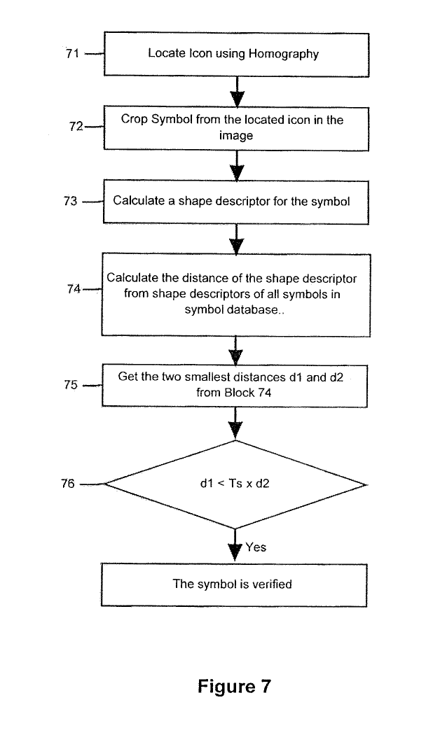

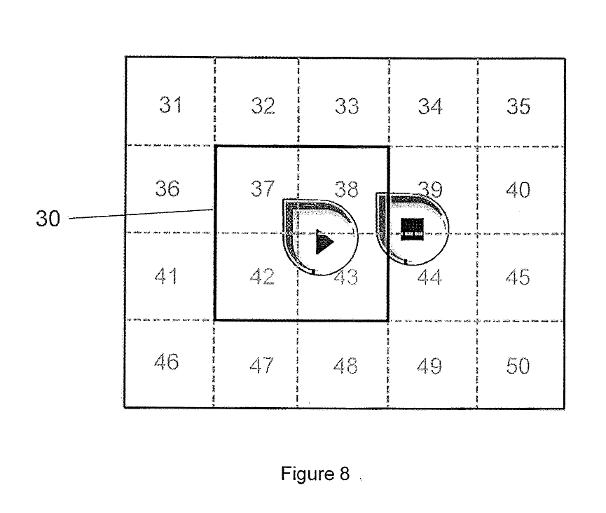

Referring back to FIG. 4, if the presence of an icon in the image is not discounted by AdaBoost algorithm Block 44 directs the computer to use a RANSAC/PROSAC to estimate a homography of the collection of keypoints. Details RANSAC/PROSAC are given later. Block 45 then directs the computer to use an inverse homography to locate the frame within the image and identify the symbol associated with the frame. Details of the locating method of Block 45 are shown in FIG. 7. At Block 71 the method locates the frame within the image using the inverse homography. At Block 72 the frame 22 is used as a reference to crop the symbol 21 from the image, thus obtaining a cropped image comprising just the symbol. In Block 73 SIFT or SURF are used to calculate descriptors for keypoints in the cropped image of the symbol 21. At Block 74 the Euclidean distances between all symbol keypoint descriptor vectors and corresponding descriptor vectors of the closest corresponding keypoints in available symbol models are calculated. Block 75 gets the minimal distance d1 and the second smallest d2 for each symbol model calculated at Block 74 and Block 76 uses these and a learned constant Ts to identify the symbol 21 in the icon. If d1<Ts·d2 for a symbol model then the symbol match the symbol of the model, others it does not.

Another of the afore mentioned problems of hitherto recognition methods is that SIFT/SURF and RANSAC/PROSAC methods have great difficulty identifying any keypoint model in and image of there are multiple similar structures of the keypoint model in the image. In a practical application of the current invention it will likely be desirable to have multiple icons in an image. To overcome this problem the image is divided into a plurality of over lapping search windows approximated to the size of the icons in the image. In SIFT/SURF, the keypoint (feature) detector will return a scale value of feature. Just imagine the features as blobs, SIFT/SURF can detect the size of the blobs in the input image. Every feature (keypoint here) detected by the SIFT/SURF detector will be associated with such a scale value. The median of the scales of these features is used as the approximated size. The purpose of the icon size estimation is not necessary to the success of recognition. It is used to accelerate the searching. If there is no such estimate, we need to try different reasonable window sizes until the icons are found.

Once the size of the search window is approximated that image is divided into a plurality of constrained search windows each having a plurality of regions. In the example illustrated on FIG. 5 each search window is divided into four equal size regions in a 2×2 format. This is not essential to the invention and the format may be 3×3 or 4×4 etc. Each of the search windows has at least one of its regions overlapping with a region of the eight immediately adjacent search windows. This is illustrates in FIG. 5 in which an image is divided into a plurality of search widows and window regions. For clarity only one ‘mid-image’ search window 30 is shown. In FIG. 5 a group of the search window regions are numbered 31, 32, 33, 34 . . . 49, 50. Regions 37, 38, 42, 43, define search window 30. The eight search windows immediately adjacent window 30 is shown in table 1 below, where window 30 is at the centre.

TABLE 1

| | | | | | |
|---|---|---|---|---|---|
| 31 | 32 | 32 | 33 | 33 | 34 |
| 36 | 37 | 37 | 38 | 39 | 39 |
| 36 | 37 | 37 | 38 | 39 | 39 |
| 41 | 42 | 42 | 43 | 43 | 44 |
| 41 | 42 | 42 | 43 | 43 | 44 |
| 46 | 47 | 47 | 48 | 48 | 49 |

In table 1 above window 30 overlaps with the window to its left (identified by regions 36, 37, 41, 42) in regions 37, 42 and with the window to its bottom right (identified by regions 43, 44, 48, 49) in region 43 for example.

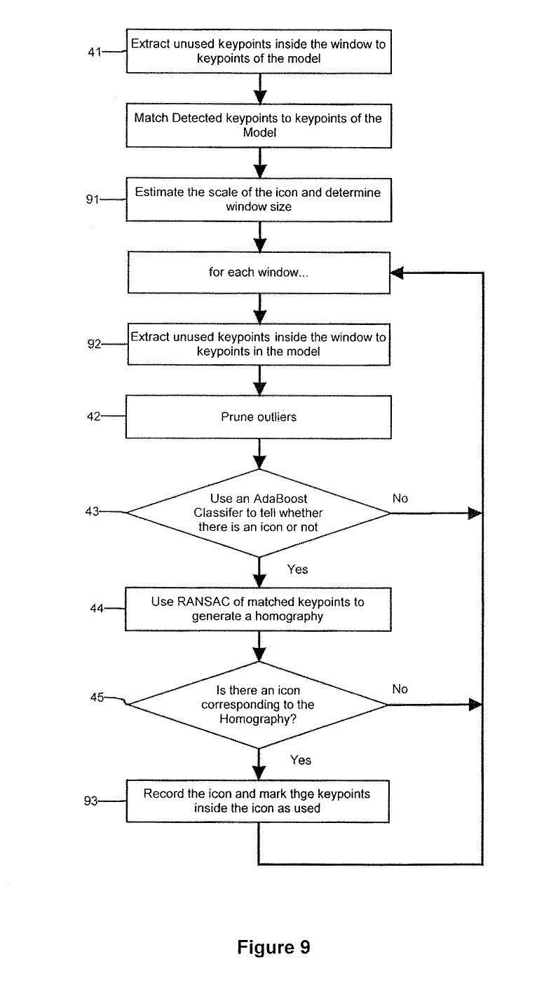

To overcome the limitations for known recognition methods a search is conducted as shown in the flow chart of FIG. 9, in which blocks have like reference numbers with FIG. 4 represent the same processes. The model of frame keywords is obtained as previously discussed using a SIFT/SURF method. The keypoints are then matched to the model using RANSAC/PROSAC for example. If a matching collection of keypoints is located in the image then the homography of the collection of keypoints is found, a transform of the located frame image obtained using an inverse homography and the symbol part of the icon cropped from image. A standard recognition method can then be used to identify the simple symbol in the cropped image. If no icon is located then an assumption can be made that two or more icons might be present in the image. At Block 91 the computer is directed to estimate the window size and the image is divided into a plurality of overlapping search windows. The search then continues iteratively in Blocks 92, 42 to 45 for each search window starting at, for example, the window defined y regions 31, 31. 36, 37. Block 92 Directs the computer to use a subset of image keypoints from within the window being searched by removing any image keypoints already identified as belonging to a located icon frame. In Block 42 outliers are also eliminated from the search subset. Although RANSAC can eliminate or is immune to outliers if many outliers exist, more iterations need to be executed. Pruning the outliers makes the method 5 to 10 times fasters.

If a matching collection of keypoints is located in a search window in Block 43 then the homography of the collection of keypoints is found in Block 44. In Block 54 transform of the located frame image is obtained using an inverse homography, the symbol part of the icon cropped from image the symbol identified in the cropped image. Returning to Block 92 on the next iteration, the image keypoints that lie within the respective overlapping region are eliminated from the subset of image keypoints used in searching the next window in the sequence. Once all search windows have been searched the method ends.

The method of recognizing an icon in an image according to the invention can be implemented in real time in a computer device. This is achieved by firstly using the AdaBoost method prior to the RANSAC/PROSAC method, allowing the RANSAC/PROSAC to be skipped if no icon is present in the search image or search window. Optionally pruning outliers also speeds up the method of recognition further, as does removing images keypoints from subsequent searches that have been used as identifiers in earlier iterations of the search. Further, by using a complex frame element combined with a simple symbol element robust computer recognition is achieved without compromising freedom and style of the indication portrayed to the human user. In yet a further aspect the invention allows for fast and robust recognition of two or more icons in a single image by dividing the image into a plurality of overlapping search windows which are iteratively search one by one. This caters for a desire to unify icon symbols within a displayed image or window.

The following is a brief discussion on the known SIFT, SURF, AdaBoost, RANSAC and PROSAC methods/

### SIFT

Scale-invariant feature transform or SIFT is an algorithm used in computer vision to detect and describe local features in images. Its applications include object recognition, robotic mapping and navigation, image stitching, 3D modeling, gesture recognition, video tracking, and match moving. A full discussion of SIFT can be found in Lowe, David G. (1999). “Object recognition from local scale-invariant features”. Proceedings of the International Conference on Computer Vision. 2. pp. 1150-1157. doi:10.1109/ICCV.1999.790410 the entire contents of which is incorporated herein by reference and in U.S. Pat. No. 6,711,293 the entire contents of which is also incorporated herein by reference.

### SURF

Speeded Up Robust Features or SURF is another algorithm used in computer vision to detect and describe local features in images that can be used in computer vision tasks like object recognition or 3D reconstruction. The standard version of SURF is several times faster than SIFT and claimed to be more robust against different image transformations than SIFT. A full discussion of SURF can be found in Herbert Bay, Andreas Ess, Tinne Tuytelaars, Luc Van Gool, “SURF: Speeded Up Robust Features”, Computer Vision and Image Understanding (CVIU), Vol. 110, No. 3, pp. 346-359, 2008 the entire contents of which is incorporated herein by reference. The SURF implementation code can be found here http://www.vision.ee.ethz.ch/˜surf/download_ac.html.

### AdaBoost

Adaptive Boosting or AdaBoost is a machine-learning algorithm that can be used in conjunction with many other learning algorithms to improve their performance. A full discussion can de found in a paper by Yoav Freund, Robert E. Schapire. “A Decision-Theoretic Generalization of on-Line Learning and an Application to Boosting”, 1995. AdaBoost is well known in the art and many teachings and discussions about AdaBoost can be found on the Internet, for example.

### RANSAC

Random Sample Consensus or RANSAC is an iterative method used to estimate parameters of a mathematical model from a set of observed data, for example the image keypoints, which contains outliers. A basic assumption is that the data consists of “inliers”, i.e., data whose distribution can be explained by some set of model parameters, and “outliers” which are data that do not fit the model. A discussion of RANSAC can be found here—Martin A. Fischler and Robert C. Bolles (June 1981). “Random Sample Consensus: A Paradigm for Model Fitting with Applications to Image Analysis and Automated Cartography”. Comm. of the ACM 24: 381-395. doi:10.1145/358669.358692, the entire contents of which in incorporated herein by reference. RANSAC has been known in the art since 1981 is well known. Many teachings and discussions about RANSAC can be found on the Internet, for example.

### PROSAC

Progressive Sample Consensus or PROSAC is a fast variant of RANSAC. In stead of random sampling, it takes the advantage of an ordering of quality of the keypoints correspondences and samples progressively. Further detail scan be found in Chum, O.; Matas, J.; “Matching with PROSAC—progressive sample consensus,” Computer Vision and Pattern Recognition, 2005. CVPR 2005. IEEE Computer Society Conference on, vol. 1, no., pp. 220-226 vol. 1, 20-25 Jun. 2005 doi: 10.1109/CVPR.2005.221.

1. A method, in a computer, of recognizing an icon in an image, the icon comprising a collection of frame keypoints and a symbol associated with the collection of frame keypoints, the method comprising:
providing a model comprising a model-collection of frame keypoints;
identifying an image-collection of frame keypoints within the image that matches the model-collection of frame keypoints;
recognizing a symbol within the image, the symbol being associated with the image-collection of frame keypoints that is identified; and
initiating an action that is associated with the symbol, within the computer or another connected computer.

2. The method of claim 1 wherein identifying an image-collection of the frame keypoints comprises:
detecting image keypoints within the image; and
identifying an image-collection of frame keypoints matching the model-collection of frame keypoints, from within the image keypoints.

3. The method of claim 1 wherein
the image contains at least two icons, and
identifying the matching image-collection of frame keypoints within the image comprises
identifying within the image a first constrained search window having a first plurality of regions,
identifying within the image a second constrained search window having a second plurality of regions, at least one of the first regions intersecting at least one of the second regions,
iteratively searching the first search window for a matching image-collection of the frame keypoints, and
subsequently searching the second search window for a matching image-collection of the frame keypoints.

4. The method of claim 3 wherein
the iterative searching comprises identifying a first matching image-collection of the frame keypoints in the first search window, and
eliminating image keypoints in the first matching collection from the searching of the second search window.

5. The method of claim 3 wherein identifying a matching image-collection of frame keypoints within the image comprises:
detecting image keypoints within the image;
identifying in the first search window a first matching image-collection of the keypoints that matches the model-collection of frame keypoints;
eliminating the first matching image-collection of keypoints from the detected image keypoints; and
searching the second search window for a second matching image-collection of the keypoints that matches the model-collection of frame keypoints.

6. The method of claim 5 further comprising eliminating outliers from the image keypoints that are detected.

7. The method of claim 1 wherein the frame image-collection of frame keypoints within the image comprises a collection of image pixels exhibiting amplitude extrema with respect to surrounding pixels.

8. The method of claim 1 wherein the model-collection of frame keypoints defines points on a frame surrounding the symbol.

9. The method of claim 1 wherein the model-collection of frame keypoints defines points on a complex image feature adjacent to the symbol.

10. The method of claim 1 wherein the model-collection of frame keypoints is unique from any keypoint of the symbol.

11. The method of claim 10 wherein
the symbol is defined by a collection of symbol keypoints, and
the collection of frame keypoints is larger than the collection of symbol keypoints.

12. A method, in a computer, of recognizing an icon in an image, the icon comprising a collection of frame keypoints and a symbol associated with the collection of frame keypoints, the method comprising:
providing a model comprising a model-collection of frame keypoints;
detecting a set of image keypoints within the image;
identifying a plurality of overlapping search windows within the image, each search window having a first region in common with an adjacent search window and a second unique region not shared by any other search window;
iteratively searching each search window, the searching comprising
searching the image keypoints within one of the search windows for a first image-collection of image keypoints matching the model-collection of frame keypoints,
eliminating any members of the image-collection from the set of image keypoints that is detected, and
searching remaining image keypoints within an adjacent one of the search windows for a second image-collection of the image keypoints that matches the model-collection of frame keypoints;
recognizing a symbol within the image, the symbol being associated with one of the image-collections of frame keypoints that is identified; and
initiating an action that is associated with the symbol, within the computer or another connected computer.

13. The method of claim 12 further comprising eliminating outliers from the set of image keypoints that is detected.

14. The method of claim 12 wherein the frame image-collection of frame keypoints within the image comprises a collection of image pixels exhibiting amplitude extrema with respect to surrounding pixels.

15. The method of claim 12 wherein the model-collection of frame keypoints defines points on a frame surrounding the symbol.

16. The method of claim 12 wherein the model-collection of frame keypoints defines points on a complex image feature adjacent to the symbol.

17. The method of claim 12 wherein the model-collection of frame keypoints is unique from any keypoint of the symbol.

18. The method of claim 12 wherein
the symbol is defined by a collection of symbol keypoints, and
the collection of frame keypoints is larger than the collection of symbol keypoints.

19. An apparatus for recognizing an icon in an image, the icon comprising frame defined by a collection of frame keypoints and a symbol associated with the frame, the apparatus comprising:
means for displaying to a user or receiving from a user an image;
a storage member;
a model stored in the memory, the model comprising a model-collection of frame keypoints;
means for identifying an image-collection of frame keypoints within the image that matches the model-collection of frame keypoints;
means for recognizing a symbol within the image, the symbol being associated with the image-collection of frame keypoint that is identified; and
means for initiating an action associated with the symbol within the computer or another connected computer.
